(19) United States
(12) Patent Application Publication
(10) Pub. No.: US 2014/0259822 A1
(43) Pub. Date: Sep. 18, 2014

(54) SWAYING WATER BALL DECORATION

(71) Applicant: CHIN-SHENG YANG, Tainan City (TW)

(72) Inventor: CHIN-SHENG YANG, Tainan City (TW)

(21) Appl. No.: 13/831,644

(22) Filed: Mar. 15, 2013

(51) Int. Cl. G09F 19/02

(52) U.S. Cl. CPC G09F 19/02
USPC 40/406

(57) ABSTRACT

The present invention provides a swaying water ball decoration, which generally includes a water ball and a swaying base. The water ball is of a light-transmitting three-dimensional configuration having a closed interior space that receives therein a sticky flowable liquid. The swaying base includes a top and a bottom that are opposite to each other. The water ball is mounted to the top. The bottom has an arc surface that serves as a movable fulcrum in a motion condition.

### TECHNICAL FIELD OF THE INVENTION

The present invention generally relates to a swaying water ball decoration, and more particularly to a decoration serving as a visual articles placed in an ambient environment.

### DESCRIPTION OF THE PRIOR ART

Commonly used decorations of daily living that are placed on desk top are generally photo frames and toy decorations. All these decorations provide only a static function of being beautiful for visual perception. An aqua light that contains therein shining flasks or powders or small decorations is available in the market, which provides a vivid visual perception of floating of the shining flasks or powders and decorations when be reversed manually or by application of electrical power. With the articles contained in the aqua light being different, the visual effect be perceived are also different and expansion of such a structure is promising to allow it to extend to various effects of visual variations or multiple functions or funs. Thus, the design of aqua light is a special topic for manufacturers of ambient decorations.

In view of this, the present invention aims to provide a decoration that, besides being placed in a static manner, provides a dynamic effect of rotation so as to provide enhanced effects of decoration, beautification, and fun.

### SUMMARY OF THE INVENTION

The primary object of the present invention is to enhance interest and dynamic structure of a water ball.

Thus, the present invention provides a swaying water ball decoration, which comprises:

a water ball, which is of a light-transmitting three-dimensional configuration having a closed interior space that receives therein a sticky flowable liquid; and

a swaying base, which comprises a top and a bottom that are opposite to each other, the water ball being mounted to the top, the bottom comprising an arc surface that serves as a movable fulcrum in a motion condition.

The present invention provides the swaying base with an arc surface so as to generate leftward/rightward sways with the bottom arc surface serving as a fulcrum thereby providing the present invention with a dynamic effect.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the present invention.

FIG. 2 is an exploded view of the present invention.

FIG. 3 is a schematic view illustrating a swaying motion of the present invention.

FIG. 4 is a cross-sectional view of the present invention.

FIG. 5 is a schematic view showing a switch set of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIGS. 1-3, which are respectively a perspective view, an exploded view, and a schematic view illustrating a swaying motion of a swaying water ball decoration according to the present invention, the swaying water ball decoration (10) generally comprises a water ball (1) and a swaying base (2). The water ball (1) is mounted on top of the swaying base (2). The swaying base (2) can sway leftwards and rightwards.

The water ball (1) is of a light-transmitting three-dimensional configuration having a closed interior space that receives therein a sticky flowable liquid. Shining powders and shining flakes are selectively added in the flowable liquid.

The swaying base (2) comprises a top (21) and a bottom (22) that are opposite to each other. The water ball (1) is mounted to a central portion of the top (21). The top (21) can be a flat surface, an arc surface, or a curved surface. In the instant embodiment, an arc surface is taken as an example. The top (21) comprises a support section (23) extending therefrom for positioning the water ball (1). The bottom (22) comprises an arc surface that is connected to the top (21) at opposite ends and bar-like portions (24) are formed at the connections. The arc surface of the bottom (22) is arranged in such a way that when the present invention is in a motion condition, the bottom (22) may serve as a movable fulcrum. The motion condition is illustrated in FIG. 3, where the swaying base (2) takes a swaying condition similar to a seesaw by following the arc surface of the bottom (22). The bar-like portions (24) help balance in the swaying motion.

Referring to FIGS. 4 and 5, the swaying base (2) comprises therein at least one light-emitting element (31) corresponding to the bottom of the water ball (1) for irradiating the light-transmitting water ball (1) to improve the beautiful visual effect. The light-emitting element (31) is controlled by a switch set (3) for lighting on/off. The switch set (3) comprises a micro-switch (33) that may conduct on a power supply (32) to cause operation of the light-emitting element (31).

The switch set (3) comprises the power supply (32), the micro-switch (33), a central control unit (34), and the light-emitting element (31). The power supply (32) can be for example a mercury cell for reducing the size thereof. The micro-switch (33) generally functions to detect minor movement for conducting on the power supply (32). The central control unit (34) is arranged to intermittently activate or to selectively activate. The light-emitting element (31) can be a light-emitting diode. As such, when the swaying base (2) sways, the micro-switch (33) detects the movement and causes the light-emitting element (31) to emit light.

Further, the present invention may further comprise an external decoration (4). The external decoration (4) is mounted outside the water ball (1). In the instant embodiment, the external decoration (4) has a configuration of “head” and “hands” of a snowman and is mounted on the water ball (1) so that the overall structure of the present invention exhibits a shape of a snowman riding a sledge. The external decoration (4) can be of an event-related shape or a shape of people, topic, or object to enhance the visual effect of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A swaying water ball decoration, comprising:
a water ball, which is of a light-transmitting three-dimensional configuration having a closed interior space that receives therein a sticky flowable liquid; and
a swaying base, which comprises a top and a bottom that are opposite to each other, the water ball being mounted to the top, the bottom comprising an arc surface that serves as a movable fulcrum in a motion condition.

2. The swaying water ball decoration according to claim 1, wherein the swaying base comprises therein at least one light-emitting element corresponding to bottom of the water ball, the light-emitting element being controlled by a switch set for lighting on/off.

3. The swaying water ball decoration device according to claim 2, wherein the switch set comprises a micro-switch that conducts on a power supply to cause operation of the light-emitting element.

4. The swaying water ball decoration according to claim 1 further comprising an external decoration that is mounted on an outer surface of the water ball.
